(19) United States
(12) Patent Application Publication
(10) Pub. No.: US 2024/0135413 A1
(43) Pub. Date: Apr. 25, 2024

(54) Processing of Queries using a Consolidated Matching Architecture

(71) Applicant: Microsoft Technology Licensing, LLC, Redmond, WA (US)

(72) Inventors: Jian JIAO, Redmond, WA (US); Eren MANAVOGLU, Menlo Park, CA (US)

(73) Assignee: Microsoft Technology Licensing, LLC, Redmond, WA (US)

(21) Appl. No.: 17/966,812

(22) Filed: Oct. 15, 2022

(51) Int. Cl. G06Q 30/02; G06F 16/951

(52) U.S. Cl. CPC G06Q 30/0277; G06F 16/951; G06Q 30/0255

(57) ABSTRACT

A query-processing technique includes an operation of matching the input query against a plurality of candidate target items, to produce a set of candidate query-item pairings. The matching is applicable to different classes of matching, but is performed by a computer processing architecture that uses a class-agnostic instance of query-processing logic and a class-agnostic target item index. After the matching operation, the technique assigns a matching class to each candidate query-item pairing in the set of candidate query-item pairings, to produce a set of classified pairings. The technique ultimately serves a particular output item to an end user, where the particular output item is chosen based on the results of the matching and assigning. Some implementations of the technique include a filtering operation whereby the candidate-item pairings are filtered to conform to a specified selection strategy or strategies. This filtering operation supplements or replaces the assigning operation.

### BACKGROUND

Traditional search systems, executed by computing devices, provide the ability to search, access, analyze, etc. vast sources of information. The same tasks cannot generally be performed in manual fashion because the information being searched is too vast in scope for manual processing, and/or because the information cannot be feasibly accessed by manual approaches, etc. Over time, the industry has incrementally improved the performance of these search systems. This has been accomplished by progressively introducing new computing devices, process flows, features, etc. to the search systems, often leaving the prior “legacy” functionality in place within the search systems. These incremental improvements to the search systems can often be expressed using various performance-based parameters, including any combination of accuracy, physical resource utilization, raw or algorithmic speed, latency, scalability, processing capacity, resource contention, power consumption, etc.

As one consequence of the above history of development, a traditional search system often uses plural query-processing engines to process a single query, each using a separate instance of query-processing logic and its own index. This is the case, for instance, in the serving of recommendations (e.g., advertisements) to a user. Here, a search system may devote different query-processing engines to the same query for different matching types on which an advertiser has bid, such as exact match, phrase-based match, and broad match (to be defined below). Each query-processing engine employs its own engine-specific quality logic to assess the quality of a match. In addition to requiring engine-specific resources, each query-processing engine requires engine-specific maintenance.

### SUMMARY

A resource-efficient technique is described herein for serving output items that are determined to match an input query. Some implementations of the technique include an operation of matching the input query against a plurality of candidate target items, to produce a set of candidate query-item pairings. The matching uses a computer processing architecture that uses a class-agnostic instance of query-processing logic and a class-agnostic target item index that apply to plural classes of matching. In some implementations, after the matching operation, the technique assigns a matching class to each candidate query-item pairing in the set of candidate query-item pairings, to produce a set of classified pairings. The technique ultimately serves at least one particular output item to an end user, where that particular output item is chosen based on the results of the matching and assigning.

The technique is technically advantageous because it eliminates or reduces reliance on the traditional use of plural query-processing engines that provide different types of query matching, and the resources consumed thereby. That is, the technique performs matching in a class-agnostic manner independent of matching class to produce class-independent matching results, and only in retrospect assigns classifications to the candidate query-item pairings; in doing so, the technique improves performance of the processing architecture as a whole, e.g., as measured by resource utilization and accuracy. The technique's use of a unified processing architecture also simplifies upkeep of the processing architecture, e.g., compared to the use of plural query-processing engines, each of which must be separately maintained.

According to some implementations, the particular output item is a document, digital advertisement, or any other information-bearing item. In some cases, a particular candidate target item is an instance of candidate keyword information submitted by an entity. In other cases, a particular candidate target item is a compilation of plural different information items associated with a particular candidate target item, such as the target item's title, body, URL address, and/or keyword information. In other examples, any of an input query, a candidate target item, and an output item can include any type of content or combination of types of content (including textual content, non-textual content, etc.). An example of non-textual content is image content.

According to some implementations, the technique further includes operations of receiving strategy information that identifies at least one end user behavior that at least one entity wishes to promote. The technique then filters the set candidate query-item pairings based on the strategy information. In some cases, the above-described assigning and filtering operations are both performed. Alternatively, the assigning operation is applied without the filtering operation, or vice versa. The filtering operation is useful to ensure that the matches identified by the matching operation have acceptable quality, which is an especially useful operation in those cases in which the technique replaces the assigning operation with the filtering operation (because the assigning operation also serves a quality-checking role).

The above-summarized technology can be manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an example of a query-processing system for processing an input query.

FIG. 2 shows a first implementation of the query-processing system of FIG. 1 that uses an index of different instances of keyword information.

FIG. 3 shows a second implementation of the query-processing system of FIG. 1 that uses an index of listing representations. Each listing representation summarizes a compilation of information items pertaining to a particular target item.

FIG. 4 shows a third implementation of the query-processing system of FIG. 1 that uses a filtering operation in place of an assigning operation.

FIG. 5 shows computing equipment that, in some implementations, is used to implement any of the query-processing systems of FIGS. 1-4.

FIG. 6 shows a user interface presentation that presents output items selected by any of the query-processing systems of FIGS. 1-4.

FIG. 7 shows a report-generating component that is used to generate a report that summarizes the operation of any of the query-processing systems of FIGS. 1-4.

FIG. 8 shows one implementation of a matching component that is used by any of the query processing systems of FIGS. 1-4.

FIG. 9 shows one implementation of a classification-assigning component, which is used by any of the query-processing systems of FIGS. 1-3.

FIG. 10 shows one implementation of a preprocessing component that is used by the query-processing systems of FIGS. 3 and 4.

FIG. 11 shows one implementation of a quality-analyzing component that is used in by the query-processing systems of FIGS. 1 and 4.

FIG. 12 shows an example of transformer-based functionality that, in some implementations, is used to implement any aspect of the query-processing systems of any of FIGS. 1-4.

FIG. 13 shows an example of convolutional neural network (CNN) functionality that, in some implementations, is used to implement any aspect of the query-processing systems of any of FIGS. 1-4.

FIG. 14 shows a first process that explains one manner of operation of any of the query-processing systems of FIGS. 1-3.

FIG. 15 shows a second process that explains one manner of operation of any of the query-processing systems of FIGS. 1 and 4.

FIG. 16 shows a third process that explains one manner of operation of the query-processing system of FIG. 1.

FIG. 17 shows an illustrative type of computing system that, in some implementations, is used to implement any aspect of the features shown in the foregoing drawings.

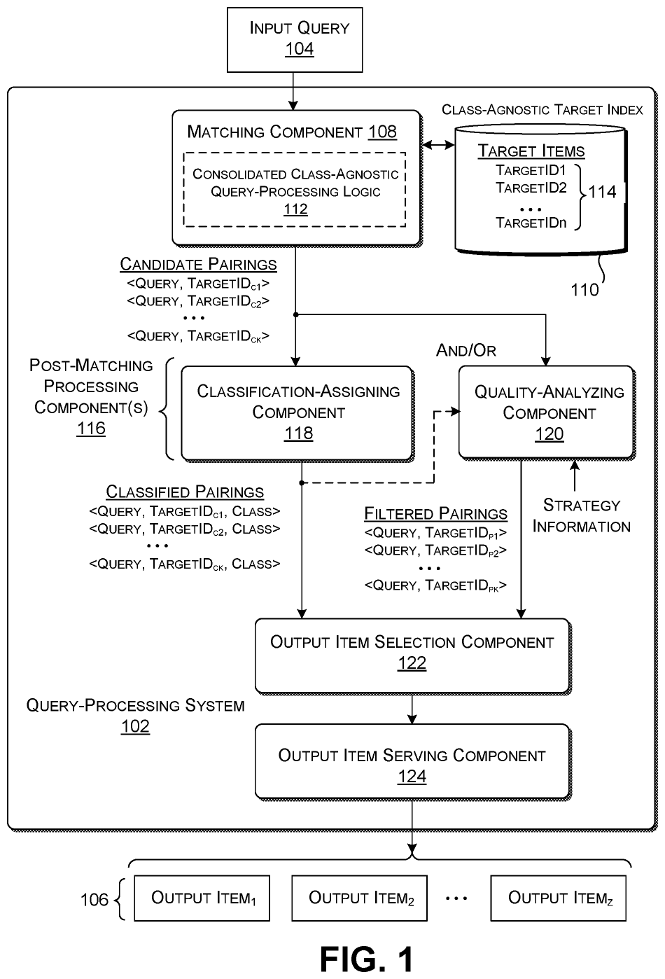

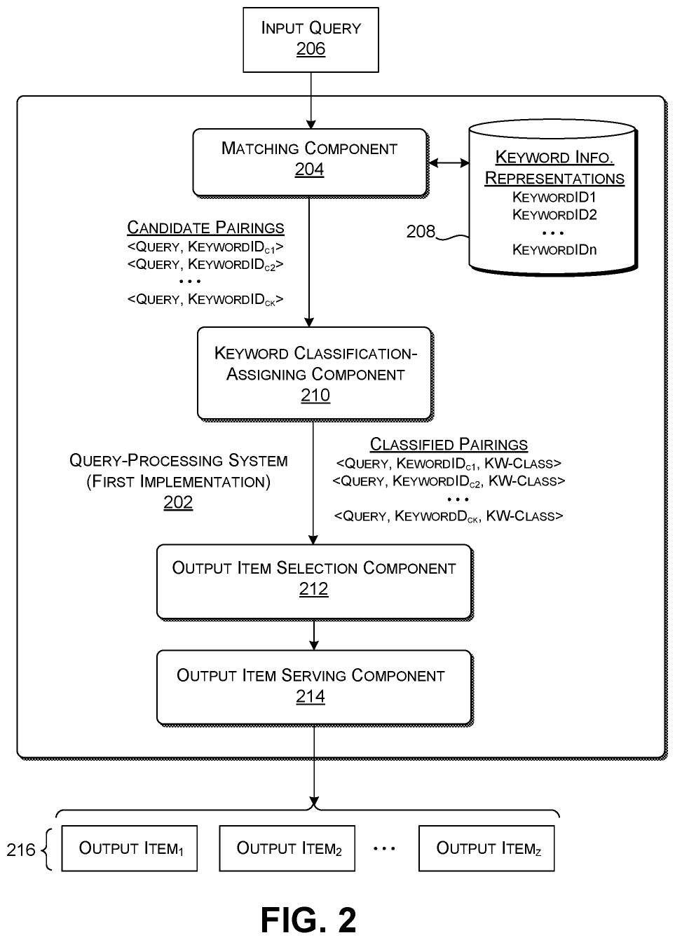

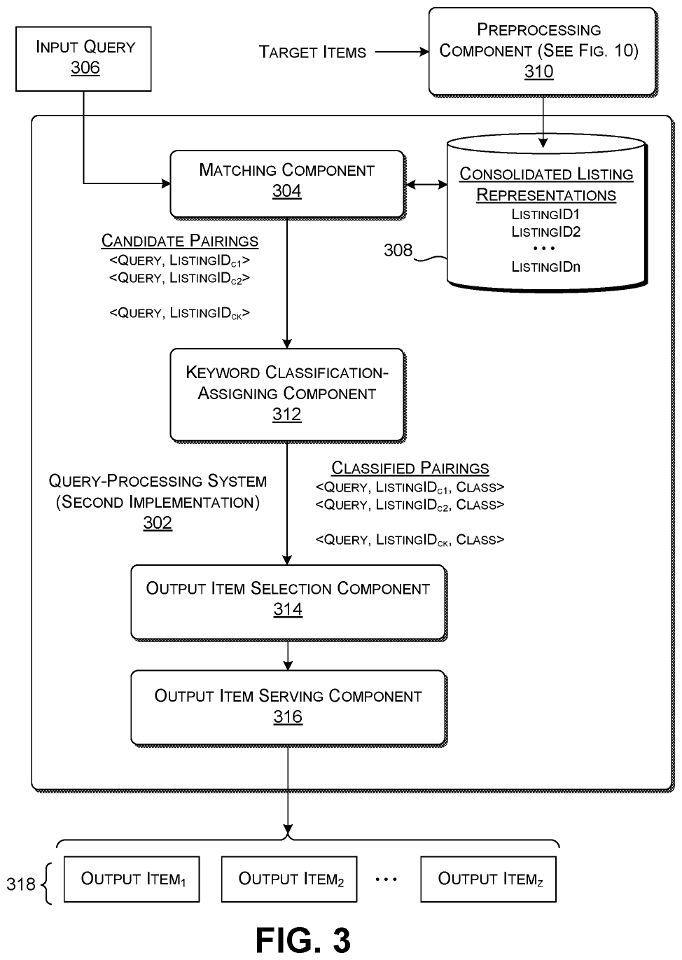

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes query-processing systems for processing a query in a resource-efficient manner. Section B sets forth illustrative methods that explain the operation of the query-processing systems of Section A. Section C describes illustrative computing functionality that, in some implementations, is used to implement any aspect of the features described in Sections A and B.

A. Illustrative Query-Processing Systems

FIG. 1 shows a first query-processing system 102 for processing an input query 104. Variants of the query-processing system 102 are shown in FIGS. 2-4, and are described below. The goal of the query-processing system 102 is to identify one or more output items 106 that are appropriate matches of the input query 104. In some cases, the input query 104 corresponds to a word or series of words (and/or other kinds of textual information) that a user inputs to a search system of any type. Alternatively, or in addition, the input query 104 corresponds to information that pertains to a current context of the user's interaction with the first query-processing system 102. For instance, assume that a user visits a web page; in this scenario, the input query 104 corresponds, at least in part, to information extracted from the web page, such as its title. In some cases, the search system is configured to perform Internet-wide searches over all publicly-accessible documents. One example of this type of search system is the BING search engine provided by Microsoft Corporation of Redmond, Washington. In other cases, the search system is associated with a website, and is configured to perform searches with respect to a set of items (e.g., products) hosted by the website.

To facilitate discussion, the examples presented below will emphasize the case in which the input query is a textual item composed of textual characters. However, the input query can more broadly include any type of content or combination of types, including textual content, non-textual content, etc. Further, because, as stated above, the input query is applicable to different input scenarios, it should be construed as any “input item.”

Likewise, what constitutes an “output item” differs in different implementations. In some cases, an output item corresponds to a digital advertisement (“ad”) that a search system serves to the user in response to the user's submission of the input query 104. In other cases, an output item corresponds to a document of any type that is determined to match the input query 104. The examples below will focus on the first-mentioned scenario, but the principles set forth with respect to this implementation are applicable to any content-retrieval operation, such as that provided by any recommendation system with respect to any information-bearing items. As with the case of the input query, the output item can include any type or types of content.

The query-processing system 102 includes a matching component 108 that performs the task of matching the input query 104 against a series of target items provided in data store 110. What constitutes a “target item” differs in different implementations. In a text-based ad-processing environment, in some implementations, a target item corresponds to an instance of keyword information submitted and possibly bid on by an entity, such as advertiser. In some cases, the keyword information includes one or more words (and/or other textual tokens) that the advertiser deems suitable to describe its product or service. For instance, a provider of a pet grooming service may choose an instance of keyword information “dog grooming.” In other examples, a target item corresponds to a representation of information item(s) pertaining to a particular document, page, or other information-bearing item. For instance, assume that the above-described pet-grooming service hosts a web page that describes its services. Here, a target item may correspond to a representation of any combination of information items associated with the web page, including any of its title, body, URL address, domain, textual keyword information, image content, etc. More generally, a target item as used herein may be considered any item from which semantic content can be extracted and against which the input query 104 may be compared, regardless of the type(s) of content it includes.

Different implementations of the matching component 108 use different techniques to match the input query 104 to the target items in the data store 110. The different techniques include various Approximate-Nearest-Neighbor (ANN) techniques, inverted index techniques, generative (e.g., sequence-to-sequence) techniques, and so on. Further, any technique can perform its matching based on any combination of lexical, semantic, contextual, etc. analysis. Additional details regarding some implementations of the matching component 108 will be provided below in the context of the description of FIG. 8. Whatever matching approach is applied, note that the query-processing system 102 will eventually produce output results that are interpreted as applying to different categories of matching. Yet the query-processing system 102 uses a class-agnostic instance of query-processing logic 112 and a class-agnostic target item index 114 for all categories of matching, to produce class-agnostic matching results. This functionality is “agnostic” in the sense that it produces its results independent of matching class. This is different from traditional approaches that use different instances of query-processing logic having their own unique target item indices and class-specific quality-checking logic to process different classes of matching.

To illustrate the above aspect of the query-processing system 102, consider a traditional ad-processing environment that allows an advertiser to choose from among three classes of matching: exact matching; phrase-based matching; and broad matching. In some implementations, the advertiser may also explicitly enter bids with respect to one or more of these types of matching. In exact matching, an input query is considered to match a particular target item because it has the same meaning as the target item. In phrase-based matching, an input query is considered to match a target item because it includes a portion that has the same meaning as the target item, but the target item does not match other portions of the input query. In broad matching, an input query is considered to match of a target item when the input query has a meaning that relates to the target item; as its name suggests, this type of matching is broader in scope than either exact matching or phrase-based matching.

For instance, consider an instance of keyword information that reads “dog grooming.” An input query that reads “dog grooming” is an exact match for the keyword information because both the keyword information and the query have exact same lexical form and the exact same meaning. An input query that reads “dog grooming and kennel service” is a phrase-based match for the keyword information because a portion of the input query (but not all of the input query) has the same meaning as the keyword information. An input query that reads “I need shampooing and boarding for my dog” is considered a broad match for the keyword information because it is likely that person who submit the input query is interested, at least in part, in a dog grooming service. Actual manifestations of these classes of searching are broadened to allow variations in prefixes, suffixes, certain synonyms (e.g., “canine” as a synonym of “dog”), etc.

A traditional ad-processing environment applies first query-processing logic for performing exact matching, with reference to a first index of target items (e.g., corresponding to a corpus of instances of keyword information to be considered for exact matching). The traditional ad-processing environment applies second query-processing logic for performing phrase-based matching, with reference to a second index of target items (e.g., corresponding to a corpus of instances of keyword information to be considered for phrase-based matching). The traditional ad-processing environment applies third query-processing logic for performing broad matching, with reference to a third index of target items (e.g., corresponding to corpus of instances of keyword information to be considered for broad matching). Further, each class-specific instance of query-processing logic incorporates class-specific quality-checking logic for ensuring that an input query matches an instance of keyword information, with respect to the class of matching (e.g., exact, phrase-based, or broad) associated with the query-processing logic. In part, the use of three instances of query-processing logic is due to the manner in which the industry and technology evolved in this subject matter domain, and a typical search system currently uses a complex layering of different functionality developed over many years to address evolving objectives and new technological discoveries. The industry further addresses new developments in data-processing technology by adding new logic “on top” of this existing hybrid body of code. In contrast, the query-processing system 102 of FIG. 1 handles all three classes of matching, but uses a single class-agnostic matching component 108 having a class-agnostic instance of query-processing logic 112 and a single class-agnostic target item index 114 for all three classes of matching. In this sense, the query-processing system 102 can be said to use a consolidated architecture.

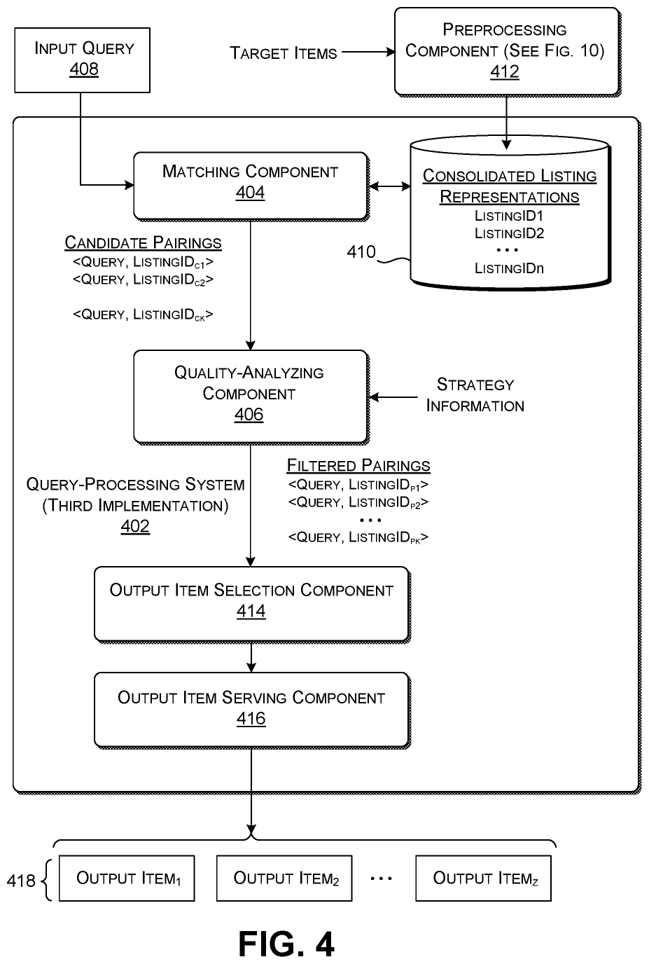

In some implementations, an advertiser or other entity can continue to discriminate among exact matching, phrase-based matching, and broad matching when it specifies and bids on keyword information or other target items. This is the case for the implementation described below with reference to FIG. 2. The matching component 108, however, will effectively consider all of the instances of the keyword information as belonging to a same generic class. In other implementations, the advertiser may dispense with the effort of discriminating among (and bidding on) different categories of matching. This is the case for the implementations described below with reference to FIGS. 3 and 4.

Note that, to facilitate explanation, this description presents examples that set forth the concepts of exact, phrase-based, and broad matching in the context of textual content. Other implementations extend these categories of matching for the case in which the items being compared have any type(s) of content, including textual and non-textual content, and for matching between items having different content types (e.g., as in the case in which an image is matched against textual keyword information). For example, a first image is considered an exact match for a second image when the semantic content of the first image is considered an exact match for the semantic content of the second image, with respect to a specified environment-specific threshold. An implementation can determine the semantic content of an image, for instance, by using a neural network to map the image into a vector in a vector space, wherein similar images have vectors that are close together in the vector space. The first image may be considered to be a phrase-based match with a second image when a part of the first image has semantic content that matches semantic content in the second image, but other parts of the two images do not match. The first image may be considered to be a broad match for the second image when they have semantically related content that does not otherwise qualify as an exact match or phrase-based match. Other implementations also take into account pixel-based comparisons between images, etc.

Further note that the concepts set forth herein are applicable to any target items on which advertisers may bid, including textual keyword information, URLs, domains, image content, etc. For this reason, any mention of target items on which a user may bid is to be broadly understood as encompassing items including any type(s) of content. Further, some examples presented below involve the use of textual keyword information; but, more generally, the concept of “keyword information” itself is to be broadly understood as encompassing any type or combination of types of content on which an entity may bid.

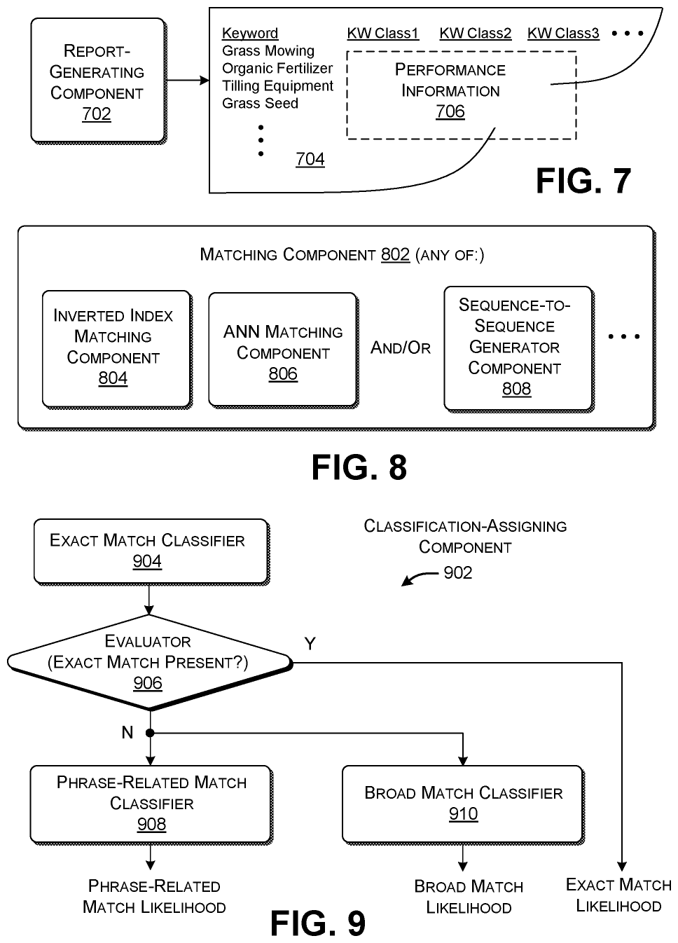

As will be described with reference to FIG. 7, in some implementations, the query-processing system 102 generates a report for the advertiser that describes the performance of the advertiser's keyword information with respect to plural classes. This is true even though the matching component 108 itself does not discriminate among different classes. This is the case for at least the implementations described below with reference to FIGS. 2 and 3.

The matching component 108 produces a set of query-item pairings. Each query-item pairing in the set of query-item pairings includes a representation of the input query 104 and a representation of a target item that is considered to match the input query, associated with an identifier referred in FIG. 1 as a TargetID. Note that all query-items pairings for a particular input query 104 will share the same representation of the input query 104.

One or more post-matching processing components 116 process the query-item pairings. In one processing path, a classification-assigning component 118 assigns a classification to each query-item pairing, to produce a classified pairing that includes a representation of the input query, a representation of the target item, and a class. Overall, the classification-assigning component 118 maps the set of query-item pairings into a set of classified pairings. In some implementations, the classification-assigning component 118 uses a machine-trained model to assign a classification to a query-item pairing. Additional details regarding some implementations of the classification-assigning operation are set forth below in the context of the explanation of FIG. 9.

Note that each input query-item pairing produced by the matching component 108 is agnostic with respect to matching class because the matching component 108 does not make distinctions for different classes of matching. The role of the classification-assigning component 118 is to examine each match between the input query and a target item to determine, post-matching or retrospectively, what type of match has been made, e.g., an exact match, a phrase-based match, or a broad match. The classification-assigning component 118 can also be viewed as consolidating the separate instances of quality-checking logic traditionally used by respective class-specific instances of quality-processing logic into a single model. That is, the classification-assigning component 118 uses a consolidated architecture to determine the probabilities that the input query 104 matches a target item for different respective kinds of matching (e.g., exact, phrase-based, or broad), therefore eliminating the need for separately-developed and separately-maintained engines to make this assessment.

The use of a class-agnostic matching component 108 is technically advantageous because it reduces the amount of resources that are needed to implement the query-processing system 102, compared to traditional designs that use different query-processing engines for handling different classes of matching. More specifically, the query-processing system 102 reduces the amount of memory that is required to perform matching because it uses a consolidated class-agnostic target item index for all classes of matching, rather than plural separately-maintained target item indexes for different classes of matching. Further, the query-processing system 102 reduces the amount of power and computing resources that are required to perform matching because it uses a consolidated class-agnostic instance of query-processing logic 112 that is applied, independent of matching class, rather than performing different query-processing flows for different matching classes.

Further, the query-processing system 102 reduces the time and effort that is required to maintain the query-processing system 102, compared to a traditional query-processing system. This is because the query-processing system 102 requires maintenance of a single centralized class-agnostic model having a consolidated instance of quality-checking logic, while a traditional query-processing system requires maintenance of plural query-processing engines having their own respective instances of quality-checking logic. Further, the class-agnostic model is expected to slowly evolve over time because it is designed at the outset to apply to a broad range of classes, and is therefore readily adaptable to new developments in matching techniques. By contrast, a traditional query-processing engine that is narrowly focused on a specific type of matching does incorporate such flexibility by design, and is therefore more subject to disruptive revision in an evolving environment. Further, when a developer does encounter the need to update the class-agnostic model to incorporate a new technique, the developer need only modify the consolidated logic of the class-agnostic model, rather than separately updating plural class-specific query-processing engines, as in the traditional approach.

Further still, the query-processing system 102 offers superior performance compared to traditional query-processing engines. This advantage is explored in greater detail below in the context of the explanation of FIG. 7.

In other implementations, the post-matching processing component(s) 116 include a quality-analyzing component 120 instead of the classification-assigning component 118. In still other implementations, the quality-analyzing component 120 operates in combination with the classification-assigning component 118. For instance, the quality-analyzing component 120 can operate on the classified pairings produced by the classification-assigning component 118. Additional details regarding one implementation of the quality-analyzing component 120 are described below in the context of the explanation of FIG. 11.

Different implementations make use of the quality-analyzing component 120 in different ways. In some implementations, the quality-analyzing component 120 receives strategy information that identifies the objectives that different entities are attempting to achieve. The quality-analyzing component 120 filters the set of candidate query-item pairings received from the matching component 108 in a way that most effectively promotes the objectives of the entities, to produce a set of filtering pairings.

More specifically, consider one illustrative manner of operation of the quality-analyzing component 120 for the input query 104 and with respect to a particular candidate query-item pairing under consideration. Assume that the candidate query-item pairing is associated with a particular target item sponsored by a particular entity. Further assume that the particular entity provides strategy information that specifies a particular objective that the particular entity is attempting to achieve with respect to the particular item. The user who submits the input query 104 is also attempting to achieve a particular objective, which is reflected in the input query 104 itself. In this situation, the quality-analyzing component 120 generates a performance measure that expresses how well the input query 104 matches or aligns with the entity's particular objective, vis-à-vis the particular target item. Upon performing this analysis for all of the query-item pairings produced by the matching component 108, the quality-analyzing component 120 identifies the candidate-item pairings that, in aggregate, are the most effective matches for the input query 104.

For example, assume that a particular entity is an advertiser who sponsors an advertisement. Instead of (or in addition to) specifying a matching class associated with the digital advertisement, the advertiser provides strategy information that describes how the advertiser is measuring the success of its advertising campaign. For instance, one advertiser may measure success of an advertising campaign based on the number of times that users click on its advertisement. Another advertiser may measure success based on a number of impressions that the advertiser receives, measured by the number of times that users are given the opportunity to act on (e.g., click on) its advertisement. Another advertiser may measure success based on a number of conversions that the advertiser receives, measured by the number of advertiser-promoted actions that users take after viewing its advertisement, such as purchasing a product or subscribing to a service. Given the input query 104, the quality-analyzing component 120 generates a performance measure that expresses how well the input query 104 will help the advertiser achieve the goal(s) of its advertising campaign.

In another case, a particular entity is a service provider which hosts a particular website. Assume that the service provider supplies strategy information that describes a particular kind of behavior that it is attempting to encourage for users who interact with its website. For example, a first service provider may wish to encourage users to click on many pages of its websites, thus maximizing each user's exposure to the content provided by the website. A second service provider may wish to encourage users to make a purchase or register for a service (or take any other action that the service provider owner regards as desirable) as quickly as possible. In this framework, the quality-analyzing component 120 generates a performance measure that identifies how well the input query 104 will lead to the end user behavior being sought by the service provider.

Consider the specific example of a user who submits the query: “I need an adaptor to charge my cell phone in Europe.” This user is likely faced with an immediate need to quickly purchase a specific type of product (a power adaptor). The matching component 108 produces a set of initial query-item pairings that are suitable for this query. The quality-analyzing component 120 then identifies those candidate query-item pairings that are aligned with the goal of a quick user purchase. Next consider a user who submits the query: “Looking for new friends that like to hike in the Pacific Northwest.” This type of user expresses a more general and potentially long-lasting goal compared to the user of the previous example. Again, the matching component 108 produces a set of initial query-item pairings that are suitable for this query. Within this set, the quality-analyzing component 120 promotes those websites that encourage users to spend a long time interacting with their content, and also that encourage return visits to the websites.

In other implementations, a single service provider implements a provider-specific version of the query-processing system 102 to process input queries submitted by users within its website, e.g., via a search interface page or other user interface component provided by the website. Further assume that the service provider identifies a single objective that it is attempting to promote. Here, the quality-assigning component 120 filters the output results of the matching component 108 in a manner that most effectively promotes the single objective. For example, assume that the service provider is attempting to encourage users to makes purchases as quickly as possible. The quality-analyzing component 120 identifies the query-item pairings that most effectively promote this particular objective. In other case, the service provider's website has different pages or subsets of pages, and the service provider identifies a desired objective for each page or subset of pages. The quality-analyzing component 120 helps direct the user to the page(s) that most effectively complement the user query 104 under consideration. The above explanation also serves to illustrate why the term “strategy information” can be said to encompass at least: the case in which plural objectives are associated with plural respective entities; the case in which plural objectives are associated with a single entity; and the case in which a single objective is associated with a single entity.

The quality-analyzing component 120 performs an especially useful role in those circumstances in which the query-processing system 102 omits the classification-assigning component 118. This is because the classification-assigning component 118 incorporates quality-checking logic that provides an assessment of the extent to which the input query 106 can be considered a suitable match for a particular target item, with respect with each of a plurality of different matching classes. The quality-analyzing component 120 also performs a quality-checking role, but assesses quality in terms of the objective(s) described in the strategy information, rather than discrete classes traditionally used in matching. In doing so, the quality-analyzing component 120 allows an advertising platform to evolve beyond those traditional classes, e.g., by providing a more general-purpose assessment of whether the input query 104 is considered a suitable match for a target item under consideration. With that said, the quality-analyzing component 120 also serves a useful function when combined with the classification-assigning component 108. In those cases, the query-processing system 102 can be considered as applying two kinds of quality analysis, a first applied by the classification-assigning component 118 and a second applied by the quality-assigning component 120.

An output item selecting component 122 chooses one or more output items 106 based on the classified pairings produced by the classification-assigning component 118 and/or the filtered pairings produced by the quality-analyzing component 120. For example, a particular classified pair describes an instance of keyword information (e.g., the phrase “lawn mowing service”) and this instance of keyword information is associated with an advertisement that is actually delivered to an end user upon his or her submission of the input query 104. In some implementations, the purpose of the output item selection component 122 is to perform additional analysis of any output item (e.g., an advertisement) prior to formally selecting it for output to the user. For example, in some implementations, the output item selecting component 122 determines whether the input query 104 matches content in the output item, such as the title of the output item. Note that this matching is different than the matching performed by the matching component 108 because the matching component 108 performs matching between the input query 104 and the target items (e.g., instances of keyword information) represented by a target item index in the data store 110, not the actual output items (e.g., advertisements) that are eventually served to end users. In other cases, the target items are the output items themselves.

In some implementations, the output item selection component 122 also takes other factors into consideration when selecting an output item. For example, the output item selection component 122 takes into account bidding information submitted by different entities for an instance of keyword information under consideration, e.g., by rewarding the instance of keyword information to the highest bidder. In addition, or alternatively, the output item selection component 122 takes into account any measured performance-related information regarding an instance of keyword information under consideration, such as its measured click-through rate over a specified period of time. In some implementations, the output item selection component 122 also incorporates any environment-specific ranking algorithms and/or machine-trained models to rank different candidate output items.

An output item serving component 124 provides the selected output item(s) to the user. For instance, in an ad-related context, the output item serving component 124 provides instructions to an application or other hosting functionality that command it to present the output item(s) on a user interface presentation. For example, assume that a user is performing a search using a search interface page of a search system. The search system provides search results via a results page. Here, the output item serving component 124 provides instructions to the search system that command it to present advertisements interspersed within search results in an environment-specific manner. Alternatively, or in addition, the search system can deliver an output item in audio form, video form, etc.

FIG. 1 has been explained for the illustrative case in which the output items are advertisements. In other cases, the query-processing system 102 uses the principles described above to match the user's input query 104 against a collection of documents of any type(s) (not necessarily advertisements), images, mixed content items, etc. For example, in one context, the user interacts with an advance search interface of a search system to specify a type of matching to perform. For instance, the user instructs the search system to find an exact match for a specified input query 104 or a phrase-based match for the input query 104. In addition, or alternatively, the user can specify that only selected parts of candidate documents be considered when performing matching, such as the titles of the documents or the abstracts of the documents. In response, the matching component 108 performs a type-agnostic matching operation, effectively ignoring the search type(s) specified by user. Nevertheless, in some implementations, the query-processing system 102 informs the user as to the documents that match his or her input query 104 for different matching classes, including the specific matching criteria selected by the user. The query-processing system 104 therefore honors the user's search selection, while notifying the user that it may be prudent to adjust the user's search criteria so as to encompass additional matching documents.

FIG. 2 shows a query-processing system 202 that represents a first implementation of the query-processing system 102 of FIG. 1. By way of overview, the query-processing system 202 uses a matching component 204, but omits the quality-analyzing component 120 shown in FIG. 1. Further, the matching component 204 matches an input query 206 against a collection of instances of textual and/or non-textual keyword information specified in a data store 208. In the nomenclature set forth above with respect to FIG. 1, an instance of keyword information constitutes a target item. In some examples, the advertisers or other entities that submit the instances of keyword information explicitly specify the types of matching to apply to the instances of keyword information. For example, assume that a particular advertiser has the winning bid for the instance of keyword information “dog grooming.” In some cases, the advertiser may explicitly specify that a specific kind (or kinds) of matching are to be used for this instance of keyword information, such as exact matching.

The matching component 204 performs a class-agnostic search using a consolidated class-agnostic instance of query-processing logic (see element 112 of FIG. 1) and a class-agnostic keyword index (see element 114 in FIG. 1) provided in the data store 208. This is true regardless of whether an advertiser or service provider specifies that different classes of matching are to be applied to different subgroups of instances of keyword information. In other words, in the initial matching stage, the matching component 204 effectively ignores the advertiser's or service provider's selection of different categories of keywords, if provided. The matching component 204 produces a set of query-item pairings, each including a representation of the input query 206 and a representation of a matching instance of keyword information specified in the data store 208.

A keyword classification-assigning component 210 retrospectively assigns a classification to each query-item pairing in the set of query-items pairings produced by the matching component 204. Overall, the keyword classification-assigning component 210 produces a set of classified pairings, each including a representation of the input query 206, a representation of a matching instance of keyword information, and a classification assigned to the input query 206 and the instance of keyword information.

A target item selection component 212 and a target item serving component 214 perform the same functions as the components (122, 124) of the same name described above in the context of FIG. 1. As a final result, the query-processing system 202 produces a set of output items 216, e.g., corresponding to a set of advertisements or documents or any other information-bearing items that match the input query 206.

FIG. 3 shows a query-processing system 302 that represents a second implementation of the query-processing system 102 of FIG. 1. By way of overview, the query-processing system 302 uses a matching component 304, but omits the quality-analyzing component 120 shown in FIG. 1. Further, the matching component 304 matches an input query 306 against a collection of listing representations in a data store 308. In the nomenclature set forth above with respect to FIG. 1, a listing representation describes a corresponding target item, which, in turn, may correspond to an advertisement, a document, image, or any other type of content item or combination thereof.

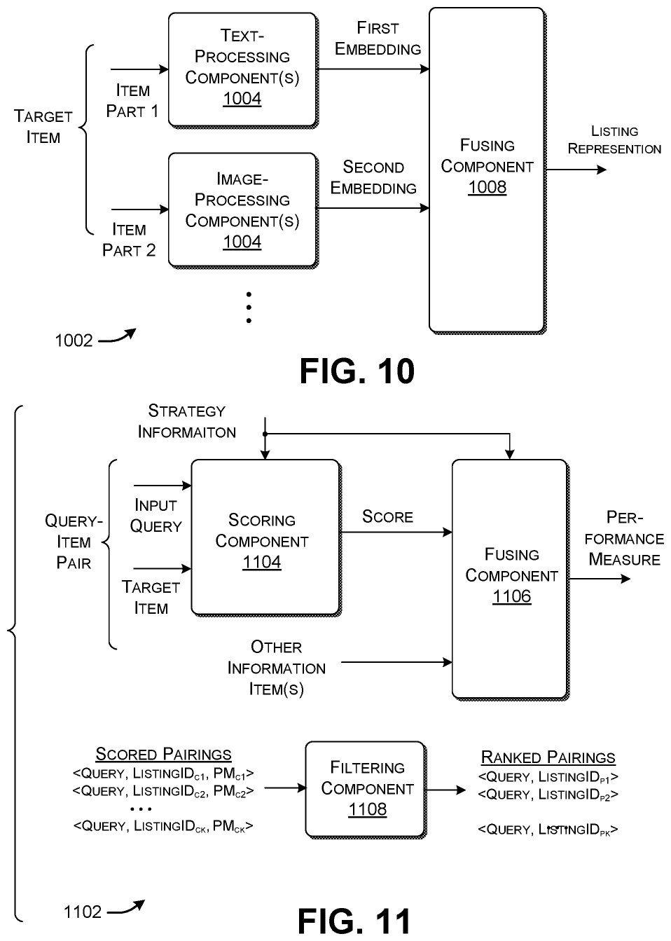

More specifically, as part of a backend process that is performed prior to matching, a preprocessing component 310 produces a plurality of listing representations for a plurality of respective target items. Each target item includes plural parts, including, for instance, a title, URL, domain, body, instance of keyword information, image content, etc. The preprocessing component 310 maps this collection of information items into a single unique identifier, referred to in FIG. 3 as a listing representation. In some implementations, the listing representation effectively encapsulates the meaning of the target item within a semantic vector space. Additional information regarding one implementation of the preprocessing component 310 will be described below in the context of the explanation of FIG. 10.

Like the prior embodiments of FIGS. 1 and 2, the matching component 304 performs a class-agnostic search using a consolidated class-agnostic instance of query-processing logic (see element 112 in FIG. 1) and a class-agnostic index of listing representations (see element 114 of FIG. 1) provided in the data store 308. The matching component 304 produces a set of query-item pairings, each including a representation of the input query 306 and a representation of a matching listing representation specified in the data store 308. A keyword classification-assigning component 312 retrospectively assigns a classification to each query-item pairing in the set of query-items pairings produced by the matching component 304. Overall, the keyword classification-assigning component 312 produces a set of classified pairings, each including a representation of the input query 306, a representation of a matching listing representation, and a classification assigned to the input query 306 and the matching listing representation.

From a high-level perspective, the query-processing system 302 of FIG. 3 performs a more generalized comparison between the input query 304 and a target item under consideration compared to the query-processing system 202 of FIG. 2. This is because the query-processing system 302 of FIG. 3 takes a more holistic approach to matching the input query 304 with candidate target items, rather than only performing query-keyword matching. But the query-processing system 302 of FIG. 3 otherwise adopts some of the same operating principles as the query-processing system 202 of FIG. 2. In the case of FIG. 3, an advertiser need not specify keyword information and need not bid on specific classes of keyword information. However, the query-processing system 302 of FIG. 3 is also applicable to the case in which the advertiser does specify keyword information and desired matching criteria.

An output item selection component 314 and an output item serving component 316 perform the same functions as the components (122, 124) of the same name described above in the context of FIG. 1. As a final result, the query-processing system 302 produces a set of output items 318, e.g., corresponding to a set of advertisements or documents or any other information-bearing items that match the input query 306.

FIG. 4 shows a query-processing system 402 that represents a third implementation of the query-processing system 102 of FIG. 1. By way of overview, the query-processing system 402 uses a matching component 404, and substitutes a quality-analyzing component 406 for the classification-assigning component 118 of FIG. 1. Further, like the second implementation of FIG. 3, the matching component 404 matches an input query 408 against a collection of listing representations in a data store 410. The advertisers need not specify keyword information and matching classes, although this possibility is not excluded. A preprocessing system 412 generates the listing representations for a plurality of respective target items in a backend process, prior to the use of the query-processing system 402 to perform matching.

Like the prior embodiments of FIGS. 1-3, the matching component 404 performs a class-agnostic search using a class-agnostic instance of query-processing logic (see element 112 of FIG. 1) and a consolidated class-agnostic list representation index (see element 114 of FIG. 1) provided in the data store 410. The matching component 404 produces a set of query-item pairings, each including a representation of the input query 408 and a representation of a matching listing representation specified in the data store 410.

The quality-analyzing component 406 performs the same function as the component with the same name in FIG. 1. That is, the quality-analyzing comment 406 filters the set of the query-items pairings produced by the matching component 404 with respect to strategy information specified by at least one entity (e.g., an advertiser or service provider). With respect to the particular entity, the strategy information specifies the type of behavior that the particular entity is attempting to promote. From a higher-level perspective, the quality-analyzing component 406 moves beyond the class-specific quality-checking performed by the classification-assigning components (118, 210, 312) of FIGS. 1-3, replacing this analysis with a different kind of analysis that assesses quality in the more broader and flexible context of an objective (or objectives) specified by the strategy information. The quality-analyzing component 406 produces a set of filtered pairings, each of which includes a representation of the input query 408 and a particular matching listing representation.

In some implementations, the data store 410 explicitly stores an identifier for each listing representation that defines the objective(s) that the entity associated with this listing representation is attempting to achieve, as specified by the strategy information. In other cases, each entity's objective(s) are defined in an entity profile created by the entity or some other data file. Here, the quality-analyzing component 406 accesses the entity's profile to determine its objective(s). In still other implementations, a single entity hosts the query-processing system 402. Here, the quality-analyzing component 406 need only take into consideration the objective(s) of the single entity.

An output item selection component 414 and an output item serving component 416 perform the same functions as the components (122, 124) of the same name described above in the context of FIG. 1. As a final result, the query-processing system 402 produces a set of output items 418, e.g., corresponding to a set of advertisements or documents or any other information-bearing items that match the input query 408.

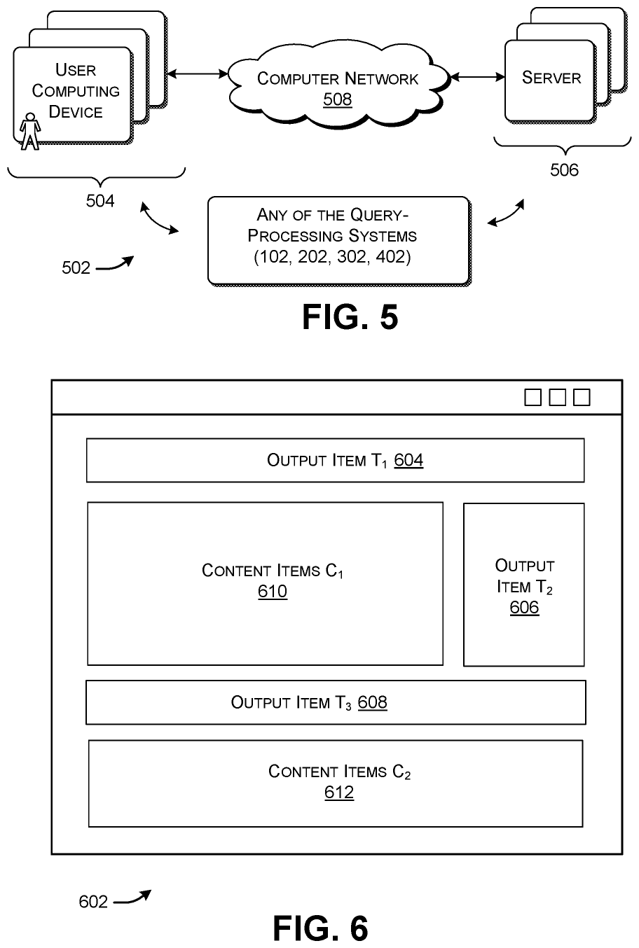

FIG. 5 shows computing equipment 502 that, in some implementations, is used to implement any of the query-processing system 102 of FIG. 1, or any of the query-processing systems (202, 302, 402) of FIGS. 2-4. The computing equipment 502 includes a set of user computing devices 504 coupled to a set of servers 506 via a computer network 508. In some implementations, each user computing device corresponds to any device that performs a computing function, including a desktop computing device, a laptop computing device, a handheld computing device of any type (e.g., a smartphone, or a tablet-type computing device), a mixed reality device, a wearable computing device, an Internet-of-Things (IoT) device, a gaming system, etc. In some implementations, the computer network 508 is implemented as a local area network, a wide area network (e.g., the Internet), one or more point-to-point links, or any combination thereof.

FIG. 5 also indicates that the functionality of any of the query processing systems can be spread across the user computing devices 504 and/or the servers 506 in any manner. For instance, in some cases, one or more of the servers 506 implement the entirety of a query-processing system. Here, each user interacts with the servers 506 via a browser application or other programmatic interfaces provided by a user computing device. In other cases, the entirety of a query-processing system is implemented by each user computing device in local fashion. In other cases, the functionality associated with a query-processing system is distributed between the servers 506 and each user computing device in any manner.

FIG. 6 shows a user interface presentation 602 that presents the output items selected by any of the query-processing systems of FIGS. 1-4. In some cases, the user interface presentation 602 presents search results produced by a search engine. In the merely illustrative example of FIG. 6, the query-processing system intersperses three output items (604, 606, 608) among the search results, generically represented by content items 610 and 612. In other examples, the user interface presentation 602 presents the content of a website of any type. Here, the query-processing system intersperses the three output items (604, 606, 608) among the web site contents, generically represented by content items 610 and 612. Generally, environment-specific ranking algorithms choose the particular placement of output items within a user interface presentation.

FIG. 7 shows a report-generating component 702 that is used to generate a report 704 that summaries operation of any of the query processing systems of FIGS. 1-4. Consider the illustrative case of the operation of the query-processing system 202 of FIG. 2. Further assume that the advertiser, a landscaping service, has chosen at least the following instances of textual keyword information to describe its business: “grass mowing,” “organic fertilizer,” “tiling equipment,” and “grass seed.” Over a span of time, the matching component 204 matches queries to these instances of keyword information, independent of matching types, even though the advertiser may have associated each instance of keyword information with a specific matching type or types in its input selections, and may have optionally entered bids with respect to a specific matching type or types. The keyword classification-assigning component 210 retrospectively assigns each instance of keyword information to at least one matching type. Overall, this yields performance information 706. For example, the performance information may reveal that the instance of keyword information “grass mowing” was matched to a certain number ne of queries, which were retrospectively classified as exact matches (e), and another number np of queries, which were retrospectively classified as phrase matches, and another number n_{b} of queries, which were retrospectively classified has broad matches.

In some implementations, the advertiser is given the ability to configure the behavior of the query-processing system 202 in different ways with respect to the relaxed matching performed by the matching component 204. For instance, an advertiser may instruct the query-processing system 202 to serve advertisements for just the specific kind of matching types that it explicitly selected. For example, assume that the advertiser has specified that only exact matching is to be used to match the instance of keyword information “grass mowing” to input queries. The advertiser is further able to instruct the query-processing system 202 to only serve advertisements for matches that have been classified as exact matches. Nevertheless, the report-generating component 702 can still inform the advertiser of how may queries matched the keyword information “grass mowing” for the phrase-based and broad match classes. This information serves as suggestions or recommendations, which may encourage the advertiser to broaden the specified matching condition to encompass phrase-based matching and/or broad matching. In other implementations, the advertiser can explicitly authorize the query-processing system 202 to deliver advertisements for all matching classes, or for at least plural specified matching classes (if not all matching classes), or for at least matches having confidence levels that satisfy a prescribed threshold value and/or other matching test(s). This implementation can be applied to the case in which the advertiser inputs no explicit class-matching criteria, and to the case in which the advertiser selects explicit class-matching criteria. For example, an advertising platform can allow an advertiser to choose a preferred matching class, but can allow the advertiser to authorize a match outside this preferred class if the match has particularly high confidence level (as defined by a prescribed threshold value). Different advertising platforms can choose different pricing models for different configuration options.

FIG. 7 highlights another technical advantage of the query-processing system 202, relative to traditional query-processing engines. In traditional query-processing engines, an advertiser may rigidly pair a specific instance of keyword information with a particular matching class. The keyword information may perform poorly for the selected matching type, but unbeknownst to the advertiser may perform better for other non-selected matching types. The query-processing system 202 provides insight into the performance of a selected instance of keyword information across different matching types. An advertiser can leverage this capability to improve the performance of the query-processing system 202, e.g., by capturing matches across different matching types of which it was previously unware.

Note that the reporting capabilities were described above in the context of the representative query-processing system 202 of FIG. 2 and text-based matching. But other query-processing systems (e.g., query processing systems 102, 302, 402) support the same capability, and can be extended to matching of items having any type(s) of content.

FIG. 8 shows one implementation of a matching component 802 that is used by any of the query processing systems of FIGS. 1-4. As generally illustrated in FIG. 8, the matching component 802 can use any type of matching technology or combination of types of matching technologies. All such implementations, however, are characterized by the use of a consolidated instance of class-agnostic query-processing functionality together with a consolidated class-agnostic target item index. That is, even though the matching component 802 can use different techniques, it is considered an integrated class-agnostic platform because none of the component techniques are developed for specific classes of matching, and none of the techniques rely on a class-specific target item index. All such implementations will be described below with reference to the query-processing system 102 of FIG. 1, although the principles set forth below are applicable to any implementation of the query-processing system and for items having any content type(s).

In a first example, an inverted index matching component 804 produces an inverted index that maps words or other units in target items to instances of target items. For example, the inverted index specifies that a particular word is found in a particular set of target documents. In some implementations, the inverted index matching component 804 consults the inverted index to discover the target items associated with each word in the input query 104 under consideration. The inverted index matching component 804 uses the raw data collected by this analysis to compute the similarity between the input query 104 and each candidate target item under consideration. One such algorithm for performing this task is the well-known term frequency-inverse document frequency (TF-IDF) algorithm.

In a second example, an approximate nearest neighbor (ANN) matching component 806 generates a representation of the input query. As a background task, a preprocessing component (not shown) uses the same conversion technique to convert each candidate target item into a representation thereof, regardless of its content type(s). The ANN matching component then finds a set of target item representations that are closest to the input query representation in a search space, where distance can be measured by any distance metric, such as cosine similarity. Background information on the general topic of ANN matching is available at Li, et al., “Approximate Nearest Neighbor Search on High Dimension Data—Experiments, Analyses, and Improvement,” arXiv, Cornell University, arXiv:1610.02455v1 [cs.DB], Oct. 8, 2016, 26 pages.

In one semantic-based approach, for example, the ANN matching component 806 uses a neural network to map the input query 104 into a query vector in a vector space. The matching component 108 then uses an ANN technique to locate one or more target vectors that are closest to the query vector, e.g., as assessed using a cosine similarity metric or any other distance metric. In a lexical-based approach, the distance between two strings can be measured based on edit distance, or any other suitable metric.

In a third example, a sequence-to-sequence generator component 808 applies a generative approach to synthesize at least one matching target item based on the input query 104. In some implementations, the sequence-to-sequence generator component 808 directly uses the synthesized target item to establish a query-item pairing. While this approach does not use the data store 110 of pre-generated target items, the sequence-to-sequence generator component 808 can be considered to employ a consolidated class-agnostic index because it maps input queries into a single target item space having a restricted vocabulary of class-agnostic target items. Some implementations of the sequence-to-sequence generator component 808 use a transformer-based standalone decoder. At each iteration in the process of generating an output sequence, a beam search algorithm performs a search within a search space that has a limited vocabulary of class-agnostic target items. Other implementations of the sequence-to-sequence generator component 808 use a recurrent neural network (RNN) that uses long short-term (LSTM) technology.

FIG. 9 shows one implementation of a classification-assigning component 902, which is used by any of the query-processing systems of FIGS. 1-3. The classification-assigning component 902 of FIG. 9 is described below with reference to the query-processing system 102 of FIG. 1, although the principles set forth below are applicable to any implementation of the query-processing system. By way of overview, the purpose of the classification-assigning operation is to assign a classification to each query-item pair in the set of query-item pairings produced by the matching component 108 of the query-processing system 102. The classification-assigning component 902 described below specifically chooses from among the exact match, phrase-based match, and broad match when classifying each query-item pair. To repeat, an exact match is one in which the target item under consideration (which, in some implementations, may be an instance of textual keyword information) has the same meaning as the input query 104. A phrase-based match is one in which the target item's meaning is included in the input query 104, but the input query 104 has other content that is not described by the target item. A broad match is one in which the target item's meaning is related to the meaning of the input query 104. However, the general principles described with respect to FIG. 9 are applicable any framework for classifying matches and any class taxonomy, and with respect to items having any type(s) of content.

An exact match classifier 904 determines the probability that the query-item pairing under consideration corresponds to an exact match. Decision block 906 determines whether the probability assessed in block 906 satisfies a prescribed threshold value. If this test is answer in the affirmative (Y), then the classification-assigning component 902 concludes that the class is exact match, without performing further analysis. The exact match classifier 904 in combination with the decision block 906 can be said to perform quality analysis with respect to the exact match class insofar as this functionality provides an assessment of whether a match can be fairly characterized as an exact match. If the test of block 906 is answered in the negative (N), a phrase-based match classifier 908 is invoked to determine a probability that the input query 104 expresses a phrase-based match, and a broad match classifier 910 is invoked to determine a probability that the input query 104 expresses a broad match. In other words, the classification-assigning operation will preclude analysis with respect with a phrase-based match and a broad match if the input query 104 is judged to be an exact match; but if an exact match is not found, then the classification-assigning operation will determine the probabilities that the input query 104 represents both a phrase-based match and a broad match. The phrase-based match classifier 908 and the broad match classifier 910 can be said to perform quality analyses with respect to the phrase-based match class and the broad match class insofar as this functionality provides assessments of whether a match can be fairly characterized as a phrase-based match and a broad match, respectively. Different implementations of the output item selection component 122 (and/or any other downstream component with respect to the classification-assigning component 118) are configured to interpret the probabilities assessed by the by the classification-assigning component 118 in different environment-specific ways.

FIG. 9 depicts the classification-assigning operation as three distinct models arranged in a hierarchical manner. This indeed reflects one implementation of the classification-assigning component 902. In other implementations, however, the classification-assigning operation 902 uses a single classifier that has three output values: the exact match likelihood, the phrase-based match likelihood, and the broad match likelihood. The classification-assigning operation 902 is configured to generate all three likelihood measures in parallel, with the phrase-based match likelihood and the broad match likelihood clamped to zero if the exact match likelihood satisfies a prescribed likelihood measure.

In some implementation, the classification-assigning component 902 is implemented using one or more machine-trained model-based classifiers, one or more rules-based classifiers, and/or or any other type(s) of classifier(s). For example, in some implementations, the classification-assigning operation is implemented by one or more transformer-based model classifiers, convolutional neural network (CNN) model classifier(s), linear regression model classifier(s), decision tree model classifier(s), random forest model classifier(s), Bayesian model classifier(s), etc.

In some implementations, a training system trains the classification-assigning component 902 in supervised fashion using a set of training examples, each positive training example specifying a particular instance of keyword information, a specific target item (e.g., a specific instance of keyword information), and a matching class identified as being appropriate (optionally with its associated probability score). The training system iteratively attempts to minimize differences between model-predicted classifications and the ground-truth classifications defined by the training examples.

FIG. 10 shows one implementation of a preprocessing component 1002 that is used by the query-processing systems of FIGS. 3 and 4. The preprocessing component 1002 is described below with reference to the query-processing system 302 of FIG. 3, although the principles set forth below are applicable to any implementation of the query-processing system. As previously described, the preprocessing component 1002 transforms a group of target items into a set of listing representations for storage in the data store 308. Each target item, in turn, is made up of one or more parts, including any of a title, a body, a URL address, domain, an instance of keyword information, image content, etc.

In some implementations, the preprocessing component 1002 uses two or more machine-trained models to process different parts of a target item. For instance, consider a document or advertisement having a URL, text content, and image content. In some implementations, the preprocessing component 1002 uses one or more text-processing components 1004 to map the text-bearing parts into a first embedding. The preprocessing component 1002 uses one or more image-processing components 1006 to map the image-bearing parts into a second embedding. For instance, in some implementations, the text processing component(s) 1006 are implemented as at least one transformer-based encoder, while the image-processing component(s) 1006 are implemented by at least transformer-based encoder (e.g., a visual transformer), a CNN, etc.

A fusing component 1008 combines (e.g., concatenates) plural input embeddings that are fed to it, and maps the combined embedding into an output result. The output result constitutes a listing representation that identifies and describes the target item. In some implementations, the fusing component 1008 is built using a fully connected neural network having any number of layers. In some implementations, a training system trains the preprocessing component 1002 such that target items that have similar meanings have listing representations that are close to each other in a target vector space.

FIG. 11 shows one implementation of quality-analyzing component 1102 that is used by the query-processing systems of FIGS. 1 and 4. The quality-analyzing component 1102 is described below with reference to the query-processing system 402 of FIG. 4, although the principles set forth below are applicable to any implementation of the query-processing system and with respect to the processing of items having any type(s) of content. The purpose of quality-analyzing component 1102 is to filter the query-item pairings produced by the matching component 404 based on strategy information specified by at least one entity (e.g., an advertiser or a service provider). In some implementations, the strategy information specifies the type of end-user behavior that each entity is attempting to promote, such as the expeditious purchase of goods and services, the exploration of a website by the end user by clicking on many pages of the website, etc.

A scoring component 1104 generates a score for each query-item pairing generated by the matching component 404. For instance, for a particular query-item pairing under consideration, assume that that the target item of this query-item pairing is associated with a particular entity, and that this entity has specified a particular objective it wishes to achieve. The scoring component 1104 maps the input query 408, the target item, and the strategy information into a score. The scoring component 1104 is implemented by any of a transformer-based encoder model, a CNN model, a linear regression model, etc. The score reflects a likelihood that the particular query-item pairing will promote the objective specified by the strategy information.

A fusing component 1106 receives the score and (optionally) one or more other information items. The fusing component 1008 combines (e.g., concatenates) the input items that are fed to it, and then maps the combined information into a performance measure. The performance measure reflects, in a more concrete manner than the score, an estimate of how well the particular query-item pairing satisfies the objective specified in the strategy information. For example, assume that an entity is an advertiser that specifies that it wishes to maximize conversion rate. Here, the fusing component 1106 generates an estimate of the conversion rate that is expected from the particular query-item pairing. In some implementations, the “other information” that is fed to the fusing component 1106 specifies any other features regarding the particular query-item pairing and/or the specified strategy information. For instance, the other information can include information describing the historical conversion rate exhibited by the particular query-item pair, or an average conversion rate exhibited by many query-item pairings, etc. In some implementations, the fusing component 1106 is implemented by a fully-connected neural network having any number of layers.

In some implementation, the single scoring component 1104 and the fusing component 1106 can be trained to produce performance measures for different objectives that may be encountered. For example, the scoring component 1104 and the fusing component 1106 can generate a first performance for the case in which the entity is attempting to maximize conversion rate, a second performance measure for the case in which the entity is attempting to maximize clicks, and a third performance measure for the case in which the entity is attempting to maximize impressions. The scoring component 1104 and the fusing component 1106 can produce three distinct performance measures in parallel, or can produce a single output result that is interpreted in different ways depending on particular objective under consideration. In other implementations, the quality-analyzing component 1102 can provide three distinct models that are trained to produce the three performance measures. The quality-analyzing component 1102 selects the model that is associated with the particular objective under consideration.

A filtering component 1108 performs a filtering operation based on a set of query-item pairings that have been processed in the manner described above by the scoring component 1104 and the fusing component 1106. In some implementations, for example, the filtering component 1108 chooses a prescribed number of query-item pairings having the most favorable performance measures. As a result of its processing, the filtering component 1108 produces a set of ranked pairings.

In some implementations, a training system trains the quality-analyzing component 1102 using supervised learning based on a set training examples. For instance, each training example may include an input query, a candidate target item, and an indication of an extent to which this query-item pairing satisfies a prescribed objective specified in strategy information. The training system attempts to produce a model that duplicates the ground-truth results set forth in the set of training examples.

Note that while training has been described above for each individual component of a query-processing system, in some implementations, the entirety of the query-processing system is implemented by a single end-to-end machine-trained model. The training system trains the entire end-to-end model in a single integrated training operation. More generally, any training described in this disclosure can use any technique(s), such as stochastic gradient descent in combination with backpropagation.

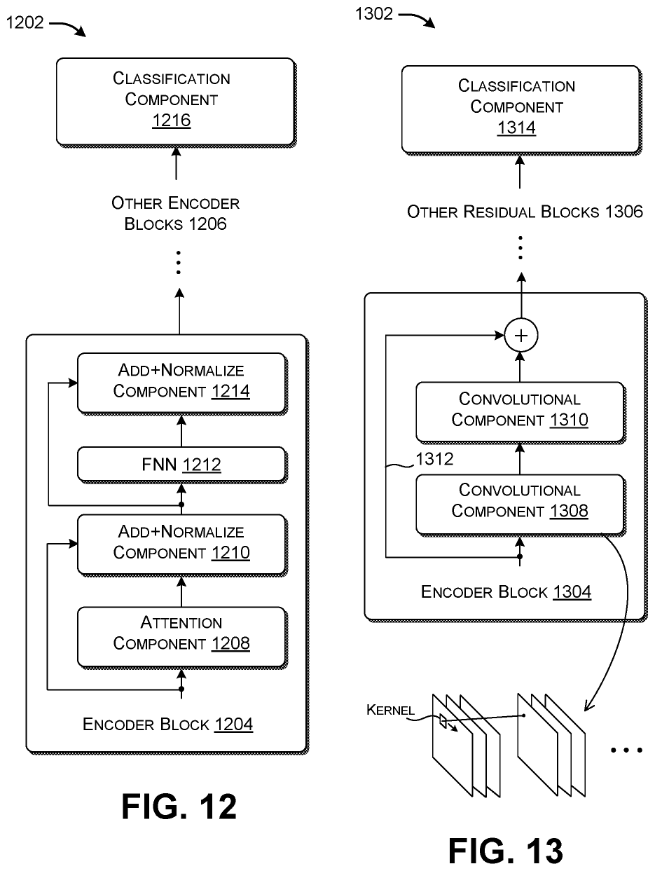

The remainder of Section A describes two non-limiting examples of machine-trained models that can be used to implement different components of the query-processing systems of FIG. 1. To being with, FIG. 12 shows a transformer-based encoder 1202. In some implementations, a query-processing system uses the transformer-based encoder to perform a classification operation based on text-based input information. The transformer-based encoder 1202 provides a pipeline that includes plural encoder blocks (e.g., encoder blocks 1204, 1206). FIG. 12 shows a representative architecture of the first encoder block 1204. Although not shown, other encoder blocks share the same architecture as the first encoder block 1204. The first encoder block 1204 includes, in order, an attention component 1208, an add-and-normalize component 1210, a feed-forward neural network (FFN) 1212, and a second add-and-normalize component 1214.

The attention component 1208 performs self-attention analysis on the input information fed to the first encoder block 1204 using the following equation:

$$Attention ( Q , K , V ) = ( \frac{Q {K}^{T}}{\sqrt{d}} ) V . \qquad ( 1 )$$

The attention component 1208 produces query information Q, key information K, and value information V shown in this equation by multiplying the input vectors fed to the attention component 1208 by three respective machine-trained matrices, W^{Q}, W^{K}, and W^{V}. More specifically, the attention component 1208 takes the dot product of Q with the transpose of K, and then divides the dot product by a scaling factor \sqrt{d}, to produce a scaled result. The symbol d represents the dimensionality of the transformer-based encoder 1202. The attention component 1208 takes the Softmax (normalized exponential function) of the scaled result, and then multiples the result of the Softmax operation by V, to produce attention output information. More generally stated, the attention component 1208 determines the importance of each input vector under consideration with respect to every other input vector. Background information regarding the general concept of attention is provided in Vaswani, et al., “Attention Is All You Need,” in 31st Conference on Neural Information Processing Systems (NIPS 2017), 2017, 11 pages

The add-and-normalize component 1210 includes a residual connection that combines (e.g., sums) input information fed to the attention component 1208 with the output information generated by the attention component 1208. The add-and-normalize component 1210 then performs a layer normalization operation on the output information generated by of the residual connection, e.g., by normalizing values in the output information based on the mean and standard deviation of those values. The other add-and-normalize component 1214 performs the same functions as the first-mentioned add-and-normalize component 1210. The FFN 1212 transforms input information to output information using a feed-forward neural network having any number of layers.

A classification component 1216 generates a classification result based on information produced by the last encoder block 1206. The classification component 1216 may be implemented as a feed-forward neural network of any type followed by a Softmax component. General background information on classifiers built using transformer-based encoders is provided in Devlin, et al., “BERT: Pre-training of Deep Bidirectional Transformers for Language Understanding,” ArXiv, Cornell University, arXiv:1810.04805v2 [cs.CL], May 24, 2019, 16 pages.

The technical literature also describes the application of transformer-based encoders to the processing of image information. General background information on this subject is provided in Dosovitskiy, et al., “An Image is Worth 16×16 Words: Transformers for Image Recognition at Scale,” arXiv, Cornell Unviersity, arXiv:2010.11929v2 [cs.CV], Jun. 3, 2021, 22 pages. The technical literature also describes the use of the transformer-based architecture in decoders to auto-generate output information. General background on this subject is provided in Brown, et al., “Language Models are Few-Shot Learners,” arXiv, Cornell University, arXiv:2005.14165v4 [cs.CL], Jul. 22, 2020, 75 pages. In some implementations, a standalone transformer-based decoder is used to implement the sequence-to-sequence generator component 808 of FIG. 8.

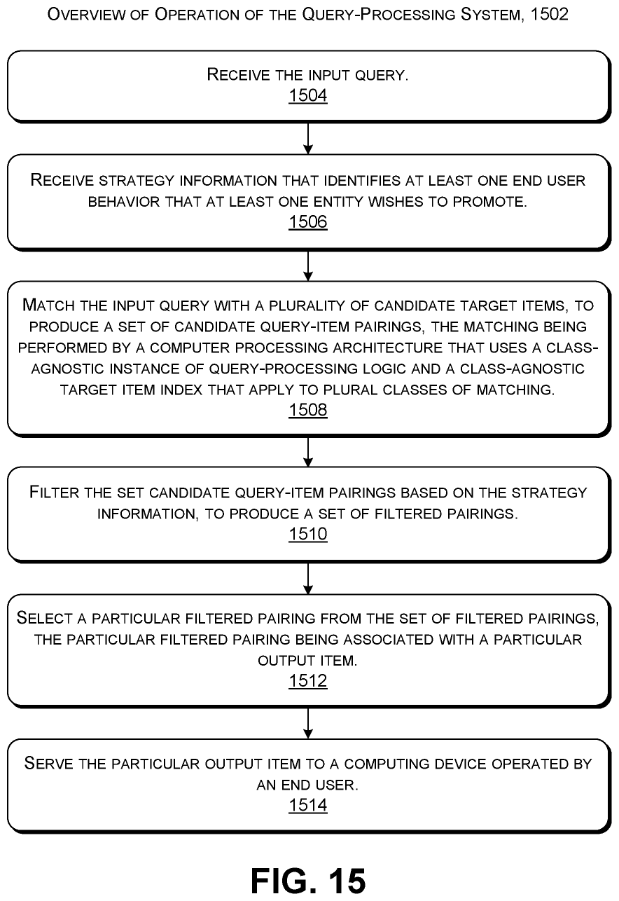

FIG. 15 shows an illustrative machine-trained CNN model 1302 that uses convolutional neural network technology. In some applications, the CNN model 1302 operates on feature information that describes text-based information. In other applications, the CNN model 1302 operates on feature information that describes image-based information. In still other applications, the CNN model 1302 operates on a combination (e.g., a concatenation) of text-based and image-based feature information.

The model CNN 1302 itself provides a pipeline that includes plural encoder blocks (e.g., encoder blocks 1304, 1306) optionally interspersed with pooling components, not shown). FIG. 13 specifically shows the merely illustrative case in which the representative encoder block 1304 includes a pair of convolutional components (1308, 1310). FIG. 13 also shows an optional residual connection 1312 that adds input information fed to the first convolutional component 1308 to output information produced by the second convolutional component 1310.

Each convolutional component performs a convolution operation that involves moving an n×m kernel (e.g., a 3×3 kernel) across feature information supplied to the convolutional component. In the case of an input image, the feature information represents image information. In the case of an input text item, the feature information represents text information. At each position of the kernel, the encoding subcomponent generates the dot product of the kernel values with the underlying values of the feature information. The bottom of FIG. 13 represents this convolution operation in high-level form. Each pooling component (not shown) down-samples results of a preceding convolutional operation using some sampling function, such as, for example, a maximum operation that selects a maximum value within a subset of values.

A classification component 1314 maps logits produced by a last encoder block 1306 to an output classification. In some implementations, the classification component 1314 is implemented by a feed-forward neural network of any type in combination with a Softmax component (that implements a normalized exponential function).

B. Illustrative Processes

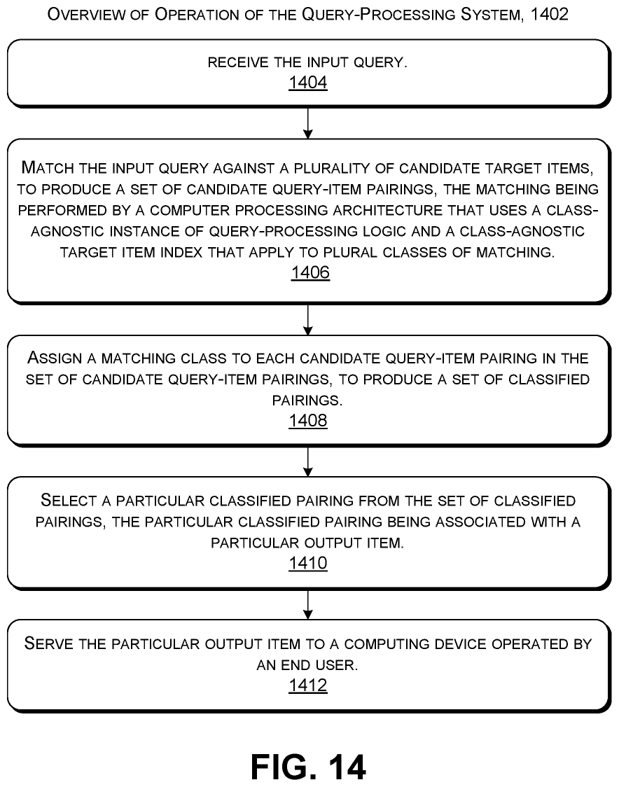

FIGS. 14-16 show illustrative processes that explain one manner of operation of the query-processing systems of Section A in flowchart form. Since the principles underlying the operation of the query-processing systems have already been described in Section A, certain operations will be addressed in summary fashion in this section. Each flowchart is expressed as a series of operations performed in a particular order. But the order of these operations is merely representative, and can be varied in other implementations. Further, any two or more operations described below can be performed in a parallel manner. In one implementation, the blocks shown in the flowcharts that pertain to processing-related functions can be implemented by the hardware logic circuitry described in Section C, which, in turn, can be implemented by one or more processors and/or other logic units that include a task-specific collection of logic gates.

FIG. 14 shows a first process 1402 that explains one manner of operation of any of the query-processing systems (e.g., 102, 202, 302) of FIGS. 1-3. In block 1404, the query-processing system receives an input query. In block 1406, the query-processing system matches the input query against a plurality of candidate target items, to produce a set of candidate query-item pairings. The matching is performed by a computer processing architecture that uses a class-agnostic instance of query-processing logic (e.g., 112) and a class-agnostic target item index that apply to plural classes of matching. In block 1408, the query-processing system assigns a matching class to each candidate query-item pairing in the set of candidate query-item pairings, to produce a set of classified pairings. In block 1410, the query-processing system selects a particular classified pairing from the set of classified pairings, the particular classified pairing being associated with a particular output item. In block 1412, the query-processing system serves the particular output item to a computing device operated by an end user. Any of the input query, any candidate target item, and the output item can have any type of content or any combination of types. This statement applies to all of the processes described herein.

FIG. 15 shows a second process 1502 that explains one manner of operation of any of the query-processing systems (e.g., 102, 402) of FIGS. 1 and 4. In block 1504, the query-processing system receives the input query. In block 1506, the query-processing system receives strategy information that identifies at least one end user behavior that at least one entity wishes to promote. In block 1508, the query-processing system matches the input query with a plurality of candidate target items, to produce a set of candidate query-item pairings. The matching is performed by a computer processing architecture that uses a class-agnostic instance of query-processing logic (e.g., 112) and a class-agnostic target item index that apply to plural classes of matching. In block 1510, the query-processing system filters the set candidate query-item pairings based on the strategy information, to produce a set of filtered pairings. In block 1512, the query-processing system selects a particular filtered pairing from the set of filtered pairings, the particular filtered pairing being associated with a particular output item. In block 1514, the query-processing system serves the particular output item to a computing device operated by an end user.

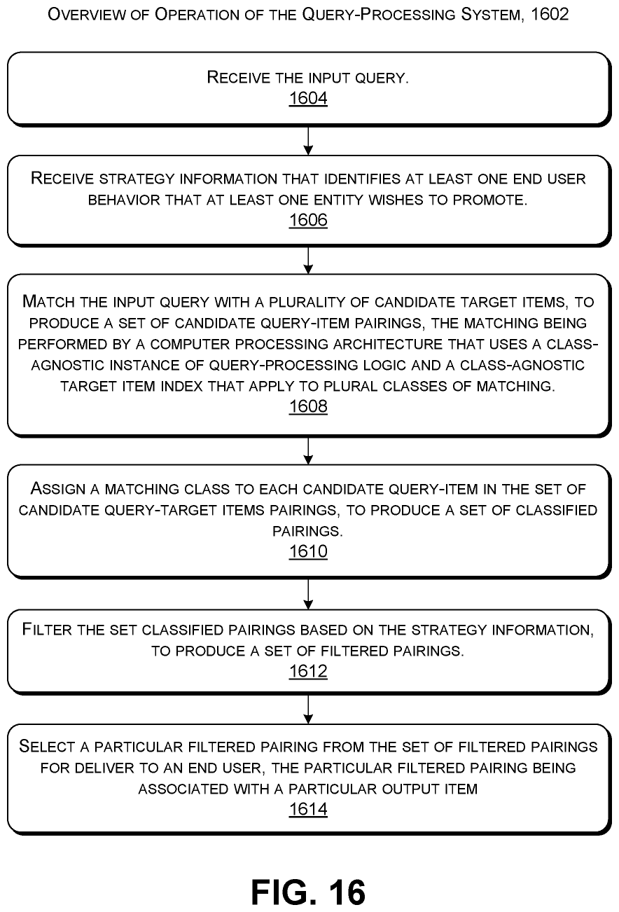

FIG. 16 shows a third process 1602 that explains one manner of operation of the query-processing systems of FIG. 1. In block 1604, the query-processing system receives the input query. In block 1606, the query-processing system receives strategy information that identifies at least one end user behavior that at least one entity wishes to promote. In block 1608, the query-processing system matches the input query with a plurality of candidate target items, to produce a set of candidate query-item pairings. The matching is performed by a computer processing architecture that uses a class-agnostic instance of query-processing logic (e.g., 112) and a class-agnostic target item index that apply to plural classes of matching. In block 1610, the query-processing system assigns a matching class to each candidate query-item in the set of candidate query-target items pairings, to produce a set of classified pairings. In block 1612, the query-processing system filters the set classified pairings based on the strategy information, to produce a set of filtered pairings. In block 1614, the query-processing system selects a particular filtered pairing from the set of filtered pairings for deliver to an end user, the particular filtered pairing being associated with a particular output item.

C. Representative Computing Functionality

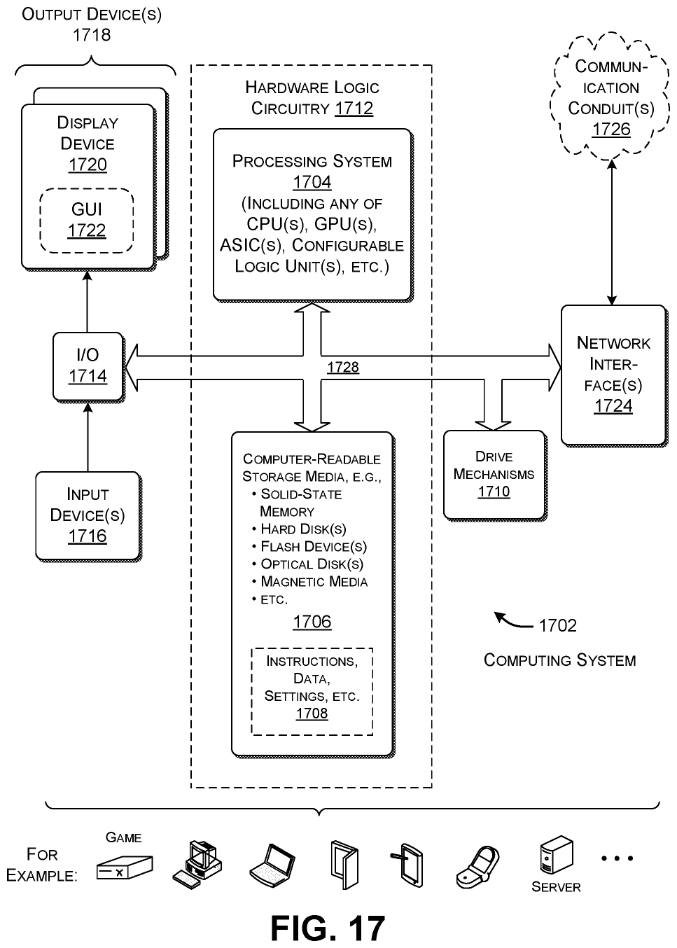

FIG. 17 shows a computing system 1702 that, in some implementations, is used to implement any aspect of the mechanisms set forth in the above-described figures. For instance, in some implementations, the type of computing system 1702 shown in FIG. 17 is used to implement any user computing device or any server shown in FIG. 5. In all cases, the computing system 1702 represents a physical and tangible processing mechanism.

The computing system 1702 includes a processing system 1704 including one or more processors. The processor(s) include one or more Central Processing Units (CPUs), and/or one or more Graphics Processing Units (GPUs), and/or one or more Application Specific Integrated Circuits (ASICs), and/or one or more Neural Processing Units (NPUs), etc. More generally, any processor corresponds to a general-purpose processing unit or an application-specific processor unit.

The computing system 1702 also includes computer-readable storage media 1706, corresponding to one or more computer-readable media hardware units. The computer-readable storage media 1706 retains any kind of information 1708, such as machine-readable instructions, settings, and/or data. For example, in some implementations, the computer-readable storage media 1706 includes one or more solid-state devices, one or more magnetic hard disks, one or more optical disks, magnetic tape, etc. Any instance of the computer-readable storage media 1706 uses any technology for storing and retrieving information. Further, any instance of the computer-readable storage media 1706 represents a fixed or removable unit of the computing system 1702. Further, any instance of the computer-readable storage media 1706 provides volatile and/or non-volatile retention of information.

More generally, any of the storage resources described herein, or any combination of the storage resources, is to be regarded as a computer-readable medium. In many cases, a computer-readable medium represents some form of physical and tangible entity. The term computer-readable medium also encompasses propagated signals, e.g., transmitted or received via a physical conduit and/or air or other wireless medium. However, the specific term “computer-readable storage medium” or “storage device” expressly excludes propagated signals per se in transit, while including all other forms of computer-readable media.

The computing system 1702 utilizes any instance of the computer-readable storage media 1706 in different ways. For example, in some implementations, any instance of the computer-readable storage media 1706 represents a hardware memory unit (such as Random Access Memory (RAM)) for storing information during execution of a program by the computing system 1702, and/or a hardware storage unit (such as a hard disk) for retaining/archiving information on a more permanent basis. In the latter case, the computing system 1702 also includes one or more drive mechanisms 1710 (such as a hard drive mechanism) for storing and retrieving information from an instance of the computer-readable storage media 1706.

In some implementations, the computing system 1702 performs any of the functions described above when the processing system 1704 executes computer-readable instructions stored in any instance of the computer-readable storage media 1706. For instance, in some implementations, the computing system 1702 carries out computer-readable instructions to perform each block of the processes described in Section B. FIG. 17 generally indicates that hardware logic circuitry 1712 includes any combination of the processing system 1704 and the computer-readable storage media 1706.

Alternatively, or in addition, the processing system 1704 includes one or more other configurable logic units that perform operations using a collection of logic gates. For instance, in some implementations, the processing system 1704 includes a fixed configuration of hardware logic gates, e.g., that are created and set at the time of manufacture, and thereafter unalterable. Alternatively, or in addition, the processing system 1704 includes a collection of programmable hardware logic gates that are set to perform different application-specific tasks. The latter category of devices includes, for example, Programmable Array Logic Devices (PALs), Generic Array Logic Devices (GALs), Complex Programmable Logic Devices (CPLDs), Field-Programmable Gate Arrays (FPGAs), etc. In these implementations, the processing system 1704 can also be said to incorporate a storage device that stores computer-readable instructions, insofar as the configurable logic units are configured to execute the instructions and therefore embody or store these instructions.

In some cases (e.g., in the case in which the computing system 1702 represents a user computing device), the computing system 1702 also includes an input/output interface 1714 for receiving various inputs (via input devices 1716), and for providing various outputs (via output devices 1718). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1720 and an associated graphical user interface presentation (GUI) 1722. The display device 1720 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1702 also includes one or more network interfaces 1724 for exchanging data with other devices via one or more communication conduits 1726. One or more communication buses 1728 communicatively couple the above-described units together.

The communication conduit(s) 1726 can be implemented in any manner, e.g., by a local area computer network, a wide area computer network (e.g., the Internet), point-to-point connections, or any combination thereof. The communication conduit(s) 1726 can include any combination of hardwired links, wireless links, routers, gateway functionality, name servers, etc., governed by any protocol or combination of protocols.

FIG. 17 shows the computing system 1702 as being composed of a discrete collection of separate units. In some cases, the collection of units corresponds to discrete hardware units provided in a computing device chassis having any form factor. FIG. 17 shows illustrative form factors in its bottom portion. In other cases, the computing system 1702 includes a hardware logic unit that integrates the functions of two or more of the units shown in FIG. 1. For instance, in some implementations, the computing system 1702 includes a system on a chip (SoC or SOC), corresponding to an integrated circuit that combines the functions of two or more of the units shown in FIG. 17.

The following summary provides a set of illustrative examples of the technology set forth herein.
(A1) According to a first aspect, some implementations of the technology described herein include a computer-implemented method (e.g., the process 1402) for processing an input query (e.g., 104). The method includes: receiving (e.g., 1404) the input query; matching (e.g., 1406) the input query against a plurality of candidate target items, to produce a set of candidate query-item pairings, the matching being performed by a computer processing architecture that uses a class-agnostic instance of query-processing logic (e.g., 112) and a class-agnostic target item index that apply to plural classes of matching; assigning (e.g., 1408) a matching class to each candidate query-item pairing in the set of candidate query-item pairings, to produce a set of classified pairings; selecting (e.g., 1410) a particular classified pairing from the set of classified pairings, the particular classified pairing being associated with a particular output item; and serving (e.g., 1412) the particular output item to a computing device (e.g., 1702) operated by an end user. The method is technically advantageous because it reduces the amount of resources (including memory and processing resources) that are required to process an input query compared to a traditional query-processing engine that uses plural instances of query-processing logic, and can be more easily managed and maintained compared to the traditional query-processing engine.
(A2) According to some implementations of the method of A1, the selecting chooses a plurality of output items, including the particular output item.
(A3) According to some implementations of any of the methods of A1 or A2, the computer-implemented method is performed by a search system, wherein the particular output item is a recommended item that the search system recommends to the end user based on the input query.
(A4) According to some implementations of any of the methods of A1-A3, a particular candidate target item of the plurality of candidate target items is an instance of keyword information submitted by an entity.
(A5) According to some implementations of any of the methods of A1-A4, another particular candidate target item of the plurality of candidate target items is a compilation of different information items pertaining to the particular candidate target item.
(A6) According to some implementations of any of the methods of A1-A5, the matching is performed for a particular candidate target item of the plurality of candidate target items by determining whether a meaning of the input query is an exact match for a meaning the particular candidate target item.
(A7) According to some implementations of the method of A6, the meaning of the input query is determined to differ from the meaning of the particular candidate target item, wherein the matching further includes: determining whether the meaning of the particular candidate item is included within the meaning of the input query; and determining whether the meaning of the particular candidate item is related to the meaning of the input query independent of a consideration of whether the meaning of the particular candidate item is included within the meaning of the input query.
(A8) According to some implementations of any of the methods of A1-A7, the computer-implemented method further includes: receiving strategy information that identifies at least one end user behavior that at least one entity wishes to promote; and filtering the set candidate query-item pairings based on the strategy information, to produce a set of filtered pairings.
(A9) According to some implementations of the method of A8, the filtering includes, for a particular candidate query-item pairing and a particular objective specified by a particular entity, determining an extent to which the particular query-item pairing satisfies the particular objective.
(A10) According to some implementations of the method of A9, the particular entity is promoting a product or service, wherein the particular objective defines a metric by which to gauge success of promotion.
(A1l) According to some implementations of the method of A9, the particular entity is a service provider, wherein the particular objective promoted by the service provider is a particular way of engaging with the service provider.
(B1) According to a second aspect, some implementations of the technology described herein include a computer-implemented method (e.g., 1502) for processing query (e.g., 402). The method includes: receiving (e.g., 1504) the input query; receiving (e.g., 1506) strategy information that identifies at least one end user behavior that at least one entity wishes to promote; matching (e.g., 1508) the input query with a plurality of candidate target items, to produce a set of candidate query-item pairings, the matching being performed by a computer processing architecture that uses a class-agnostic instance of query-processing logic (e.g., 112) and a class-agnostic target item index that apply to plural classes of matching; filtering (e.g., 1510) the set candidate query-item pairings based on the strategy information, to produce a set of filtered pairings; selecting (e.g., 1512) a particular filtered pairing from the set of filtered pairings, the particular filtered pairing being associated with a particular output item; and serving (e.g., 1514) the particular output item to a computing device operated by an end user. The method of B1 has at least the same technical benefits as the method of A1.
(C1) According to a second aspect, some implementations of the technology described herein include a computer-implemented method (e.g., 1602) for processing a query (e.g., 104). The method includes: receiving (1604) the input query; receiving (e.g., 1606) strategy information that identifies at least one end user behavior that at least one entity wishes to promote; matching (e.g., 1608) the input query with a plurality of candidate target items, to produce a set of candidate query-item pairings, the matching being performed by a computer processing architecture that uses a class-agnostic instance of query-processing logic (e.g., 112) and a class-agnostic target item index that apply to plural classes of matching; assigning (e.g., 1610) a matching class to each candidate query-item in the set of candidate query-target items pairings, to produce a set of classified pairings; filtering (e.g., 1612) the set classified pairings based on the strategy information, to produce a set of filtered pairings; and selecting (e.g., 1614) a particular filtered pairing from the set of filtered pairings for deliver to an end user, the particular filtered pairing being associated with a particular output item. The method of C1 has at least the same technical benefits as the method of A1.

In yet another aspect, some implementations of the technology described herein include a computing system (e.g., the computing system 1702) that includes a processing system (e.g., the processing system 1704) having a processor. The computing system also includes a storage device (e.g., the computer-readable storage media 1706) for storing computer-readable instructions (e.g., information 1708) that, when executed by the processing system, perform any of the methods described herein (e.g., any of the methods of A1-A11, B1, or C1).

In yet another aspect, some implementations of the technology described herein include a computer-readable storage medium (e.g., the computer-readable storage media 1706) for storing computer-readable instructions (e.g., the information 1708). A processing system (e.g., the processing system 1704) executes the computer-readable instructions to perform any of the operations described herein (e.g., the operation in any of the methods of A1-A11, B1, or C1).

More generally stated, any of the individual elements and steps described herein can be combined, for example, into any logically consistent permutation or subset. Further, any such combination can be manifested, for example, as a method, device, system, computer-readable storage medium, data structure, article of manufacture, graphical user interface presentation, etc. The technology can also be expressed as a series of means-plus-format elements in the claims, although this format should not be considered to be invoked unless the phase “means for” is explicitly used in the claims.

As to terminology used in this description, the phrase “configured to” encompasses various physical and tangible mechanisms for performing an identified operation. The mechanisms can be configured to perform an operation using the hardware logic circuitry 1712 of Section C. The term “logic” likewise encompasses various physical and tangible mechanisms for performing a task. For instance, each processing-related operation illustrated in the flowcharts of Section B corresponds to a logic component for performing that operation.

This description may have identified one or more features as “optional.” This type of statement is not to be interpreted as an exhaustive indication of features that may be considered optional; that is, other features can be considered as optional, although not explicitly identified in the text. Further, any mention of a single entity is not intended to preclude the use of plural such entities; similarly, a description of plural entities in the specification is not intended to preclude the use of a single entity. As such, a statement that an apparatus or method has a feature X does not preclude the possibility that it has additional features. Further, while the description may explain certain features as alternative ways of carrying out identified functions or implementing identified mechanisms, the features can also be combined together in any combination. Further, the term “plurality” or “plural” or the plural form of any term (without explicit use of “plurality” or “plural”) refers to two or more items, and does not necessarily imply “all” items of a particular kind, unless otherwise explicitly specified. The phrase “at least one of” refers to one or more items. The disclosure may use the phrase “at least one” when identifying some items, but not other items; any reference to a single item, without explicit recitation of “at least one of,” is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. Further, the terms “comprising,” “including,” and “having” are open-ended terms that are used to identify at least one part of a larger whole, but not necessarily all parts of the whole. A “set” can include zero members, one member, or more than one member. Finally, the terms “exemplary” or “illustrative” refer to one implementation among potentially many implementations.

In closing, the functionality described herein can employ various mechanisms to ensure that any user data is handled in a manner that conforms to applicable laws, social norms, and the expectations and preferences of individual users. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for processing an input query, comprising:
receiving the input query;
matching the input query against a plurality of candidate target items, to produce a set of candidate query-item pairings, the matching being performed by a computer processing architecture that uses a class-agnostic instance of query-processing logic and a class-agnostic target item index that apply to plural classes of matching;
assigning a matching class to each candidate query-item pairing in the set of candidate query-item pairings, to produce a set of classified pairings;
selecting a particular classified pairing from the set of classified pairings, the particular classified pairing being associated with a particular output item; and
serving the particular output item to a computing device operated by an end user.

2. The computer-implemented method of claim 1, wherein the selecting chooses a plurality of output items, including the particular output item.

3. The computer-implemented method of claim 1, wherein the computer-implemented method is performed by a search system, and wherein the particular output item is a recommended item that the search system recommends to the end user based on the input query.

4. The computer-implemented method of claim 1, wherein a particular candidate target item of the plurality of candidate target items is an instance of keyword information submitted by an entity.

5. The computer-implemented method of claim 1, wherein a particular candidate target item of the plurality of candidate target items is a compilation of different information items pertaining to the particular candidate target item.

6. The computer-implemented method of claim 1, wherein the matching is performed for a particular candidate target item of the plurality of candidate target items by determining whether a meaning of the input query is an exact match for a meaning the particular candidate target item.

7. The computer-implemented method of claim 6, wherein the meaning of the input query is determined to differ from the meaning of the particular candidate target item, and wherein the matching further includes:
determining whether the meaning of the particular candidate item is included within the meaning of the input query; and
determining whether the meaning of the particular candidate item is related to the meaning of the input query independent of a consideration of whether the meaning of the particular candidate item is included within the meaning of the input query.

8. The computer-implemented method of claim 1, further including:
receiving strategy information that identifies at least one end user behavior that at least one entity wishes to promote; and
filtering the set candidate query-item pairings based on the strategy information, to produce a set of filtered pairings.

9. The computer-implemented method of claim 8, wherein the filtering includes, for a particular candidate query-item pairing and a particular objective specified by a particular entity, determining an extent to which the particular query-item pairing satisfies the particular objective.

10. The computer-implemented method of claim 9, wherein the particular entity is promoting a product or service, and wherein the particular objective defines a metric by which to gauge success of promotion.

11. The computer-implemented method of claim 9, wherein the particular entity is a service provider, and wherein the particular objective defines a particular way of engaging with the service provider to advance a stated objective.

12. A computing system for processing an input query, comprising:
a processing system comprising a processor; and
a storage device for storing machine-readable instructions that, when executed by the processing system, perform operations comprising:
receiving the input query;
receiving strategy information that identifies at least one end user behavior that at least one entity wishes to promote;
matching the input query with a plurality of candidate target items, to produce a set of candidate query-item pairings, the matching being performed by a computer processing architecture that uses a class-agnostic instance of query-processing logic and a class-agnostic target item index that apply to plural classes of matching;
filtering the set candidate query-item pairings based on the strategy information, to produce a set of filtered pairings;
selecting a particular filtered pairing from the set of filtered pairings, the particular filtered pairing being associated with a particular output item; and
serving the particular output item to a computing device operated by an end user.

13. The computing system of claim 12, wherein a particular candidate target item of the plurality of candidate target items is an instance of keyword information submitted by the entity.

14. The computing system of claim 12, wherein a particular candidate target item of the plurality of candidate target items is a compilation of different information items pertaining to the particular candidate target item.

15. The computing system of claim 12, wherein the filtering includes, for a particular candidate query-item pairing and a particular objective specified by a particular entity, determining an extent to which the particular query-item pairing satisfies the particular objective.

16. The computing system of claim 15, wherein the particular entity is promoting a product or service, and wherein the particular objective defines a metric by which to gauge success of promotion.

17. The computing system of claim 15, wherein the particular entity is a service provider, and wherein the particular objective promoted by the service provider is a particular way of engaging with the service provider to advance a stated objective.

18. A computer-readable storage medium for storing computer-readable instructions, wherein a processing system executes the computer-readable instructions to perform operations comprising:
receiving an input query;
receiving strategy information that identifies at least one end user behavior that at least one entity wishes to promote;
matching the input query with a plurality of candidate target items, to produce a set of candidate query-item pairings, the matching being performed by a computer processing architecture that uses a class-agnostic instance of query-processing logic and a class-agnostic target item index that apply to plural classes of matching;
assigning a matching class to each candidate query-item in the set of candidate query-target items pairings, to produce a set of classified pairings;
filtering the set classified pairings based on the strategy information, to produce a set of filtered pairings; and
selecting a particular filtered pairing from the set of filtered pairings for deliver to an end user, the particular filtered pairing being associated with a particular output item.

19. The computer-readable storage medium of claim 18, wherein a particular candidate target item of the plurality of candidate target items is an instance of keyword information submitted by the entity.

20. The computer-readable storage medium of claim 18, wherein a particular candidate target item of the plurality of candidate target items is a compilation of different information items pertaining to the particular candidate target item.
